(19) United States
(12) Patent Application Publication
(10) Pub. No.: US 2014/0013668 A1
(43) Pub. Date: Jan. 16, 2014

(54) Sliding Door Cover Rail

(71) Applicant: ASI TECHNOLOGIES, INC., Milwaukee, WI (US)

(72) Inventors: George F. Balbach, Lake Bluff, IL (US); James E. Equitz, Slinger, WI (US)

(21) Appl. No.: 13/929,212

(22) Filed: Jun. 27, 2013

Related U.S. Application Data
(60) Provisional application No. 61/670,950, filed on Jul. 12, 2012.

(51) Int. Cl. E05D 15/06

(52) U.S. Cl. CPC E05D 15/0652
USPC 49/409

(57) ABSTRACT

An industrial sliding door for closing off a door opening in a wall of a structure includes a door panel that extends vertically for substantially the height of the door opening and horizontally between an inward edge of the door panel and an outward edge of the door panel and covers at least a portion of the door opening when the door is closed. The sliding door also includes a trolley assembly that is coupled to the door panel and that includes a track component. A shroud covers the trolley assembly and forms a rail for the track component. A drive assembly drives the trolley assembly to open and close the door opening and is positioned below a top panel of the shroud and behind a front panel of the shroud and between the trolley assembly and the wall.

### CROSS-REFERENCE TO RELATED APPLICATION

This application claims the benefit of U.S. Provisional Patent Application No. 61/670,950 filed Jul. 12, 2012, the disclosure of which is hereby incorporated by reference.

### STATEMENT CONCERNING FEDERALLY SPONSORED RESEARCH OR DEVELOPMENT

Not applicable.

### FIELD OF THE INVENTION

This invention relates to industrial doors, and in particular to a sliding industrial door that has a cover that forms a rail.

### BACKGROUND OF THE INVENTION

Sliding doors for industrial applications are well known and used in a variety of applications. For example, sliding doors are used in industrial freezers where traffic is common, requiring the doors to slide open and closed frequently. Sliding doors typically include one or more door panels that are suspended by a trolley assembly connected to the sliding door panel that has wheels that engage a rail assembly that is mounted to the wall over the door opening. A shroud usually covers the trolley assembly and the rail assembly. There may also be tracks on the floor at the bottom of the door opening to hold the bottom of the door close to the door opening.

The sliding door can be configured to have just one door panel or have two door panels that meet in the middle of the door opening. The door panels are typically operated by an endless drive member which is power driven at the top of the door opening. A lower run of the endless drive member is attached to the door panel, so that depending on which way the endless drive member is driven, the door panel can open or close the door opening. In the case of two door panels meeting in the middle, the lower run of the endless drive member is attached to one of the panels and an upper run of the endless drive member is attached to the other panel, so that when the endless drive member is driven, the panels move away from one another to open the door opening. When the endless drive member is driven in the other direction, the panels move together toward one another to close the door opening. The opening of the door is typically actuated by a motion detector, a pull cord connected to a switch or an induction loop in the floor that senses the presence of a vehicle or object.

These sliding doors of the prior art have the drive system mounted exterior to the rail assembly and the trolley assembly. This requires that the shroud be rather large to cover and protect the rail assembly, trolley assembly, and the drive system components. In addition to the large shroud being unsightly, the position of the drive system requires the drive system components of the motor, endless drive member, and pulleys to be cantilevered rather far from the wall, which requires more complicated mounting assemblies and increased time for installation.

### SUMMARY OF THE INVENTION

The present invention provides a sliding door that addresses these issues. In one embodiment, the invention provides for a laterally sliding door for closing off a door opening in a wall of a structure. The laterally sliding door includes a door panel that extends vertically for substantially the height of the door opening and horizontally between an inward edge of the door panel and an outward edge of the door panel so as to cover at least a portion of the door opening when the door is closed. The sliding door also includes a trolley assembly coupled to the door panel. The trolley assembly includes a track component. A shroud covers the trolley assembly and forms a rail for the track component. The sliding door also includes a drive assembly for driving the trolley assembly to open and close the door opening. The drive assembly is positioned below a top panel of the shroud and behind a front panel of the shroud and is between the trolley assembly and the wall.

In another aspect of the invention, the invention provides for a sliding door for closing off a door opening in a wall of a structure. The sliding door includes a door panel that extends substantially the height of the door opening and between an inward edge of the door panel and an outward edge of the door panel so as to cover at least a portion of the door opening when the door is closed. A trolley assembly is coupled to the door panel and includes a track component. A shroud covers the trolley assembly and forms a rail for the track component. The sliding door also includes a drive assembly for driving the trolley assembly to open and close the door opening. The drive assembly is closer to the wall of the structure than the rail is to the wall of the structure.

In yet another aspect of the invention, the invention provides for a sliding door for closing off a door opening in a wall of a structure. The sliding door includes a header coupled to the wall of the structure. The sliding door also includes a door panel that extends substantially the height of the door opening and between an inward edge of the door panel and an outward edge of the door panel so as to cover at least a portion of the door opening when the door is closed. A trolley assembly is coupled to the door panel and forms a rail for the track component. A shroud is coupled to the header and covers the trolley assembly and forms a rail for the track component. The sliding door also includes a drive assembly for driving the trolley assembly to open and close the door opening. A drive assembly drives the trolley assembly to open and close the door opening, the drive assembly being closer to the header than the track component is to the header.

These and other features and advantages of the invention will be apparent from the detailed description and drawings.

### BRIEF DESCRIPTION OF THE DRAWINGS

FIG. 1 is a front, top, right perspective view of a sliding door assembly partially covering a door opening in a wall of a structure;

FIG. 2 is a front elevational view of the sliding door assembly of FIG. 1;

FIG. 3 is a front, top, left perspective view of the sliding door assembly of FIG. 1, the structure being removed;

FIG. 4 is a front, top, left perspective view of the sliding door assembly of FIG. 3, the shroud being removed;

FIG. 5A is a detailed, cut-away view taken along line 5A-5A from FIG. 3;

FIG. 5B is a detailed, cross-sectional view taken along line 5B-5B from FIG. 3;

FIG. 6A is a detailed, side elevational view showing a sliding door assembly of FIG. 1 in an open position; and

FIG. 6B is a detailed, side elevational view showing a sliding door assembly of FIG. 1 in a closed position.

### DETAILED DESCRIPTION OF THE PREFERRED EMBODIMENT

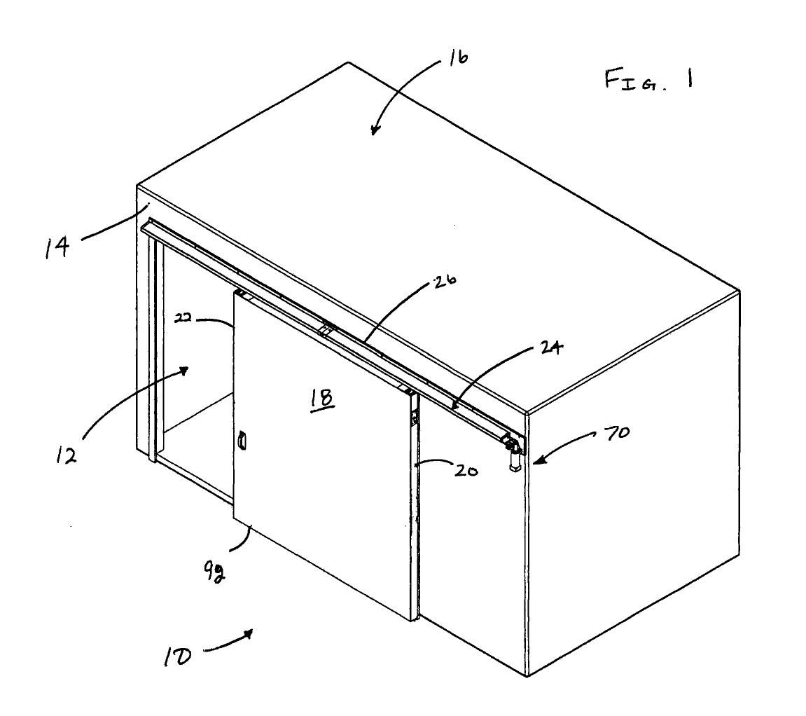

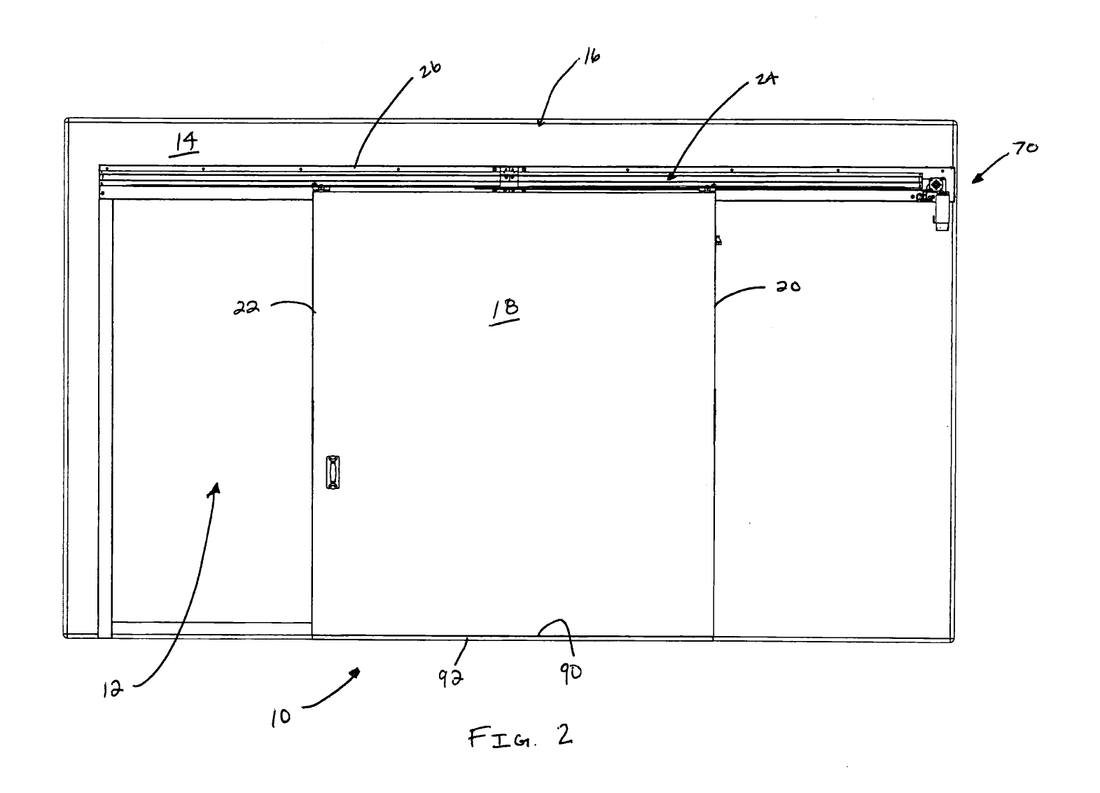

FIGS. 1-4 illustrate a sliding door assembly 10. As illustrated in FIGS. 1 and 2, the sliding door assembly 10 laterally slides from an open position to a closed position for closing off a door opening 12 in a wall 14 of a structure 16. The sliding door assembly 10 includes a door panel 18 that extends vertically for substantially the height of the door opening 12 and horizontally between an inward edge 20 of the door panel 18 and an outward edge 22 of the door panel 18 so as to cover at least a portion of the door opening 12 when the sliding door assembly 10 is closed. A shroud 24 also forms part of the sliding door assembly 10. As shown in FIGS. 1 and 2, the shroud 24 is coupled to a header 26 that is coupled to the wall 14 of the structure 16.

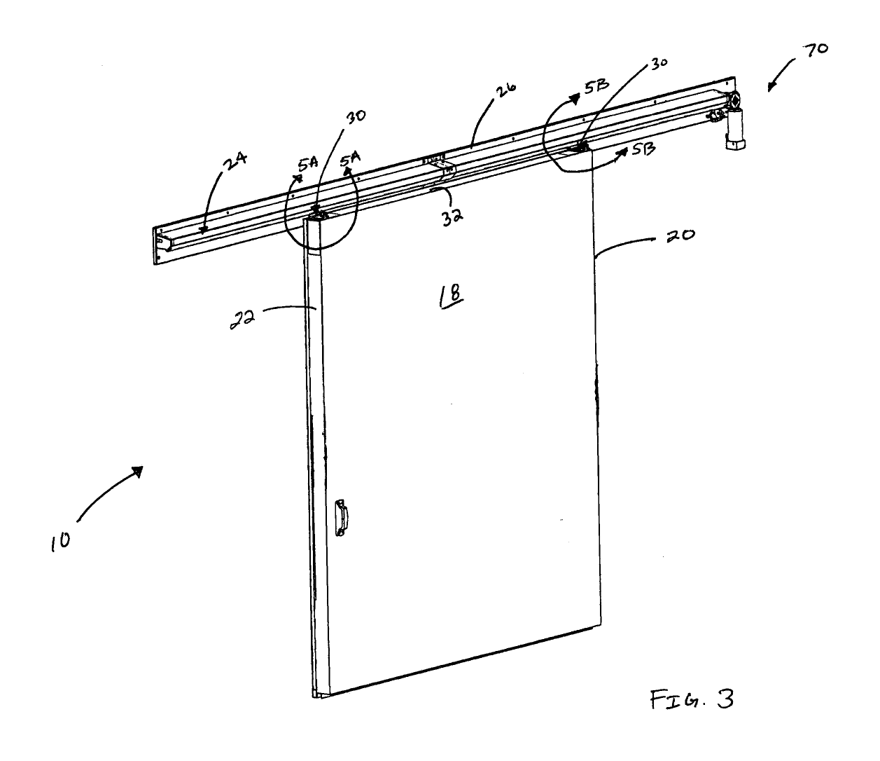

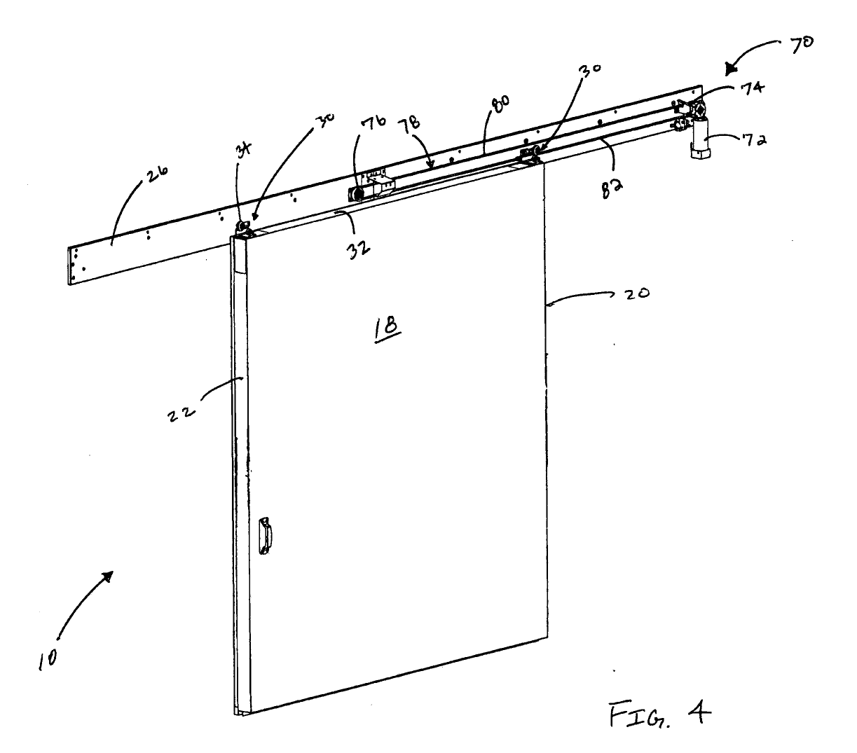

In FIGS. 3 and 4, the structure 16 is removed to provide further clarity to the sliding door assembly 10. The shroud 24 is also removed in FIG. 4 to show other components of the sliding door assembly 10. Two trolley assemblies 30 are coupled to the door panel 18, one trolley assembly 30 being closer to the inward edge 20 of the door panel 18 and the other trolley assembly 30 being closer to the outward edge 22 of the door panel 18. The trolley assemblies 30 are coupled to a top side 32 of the door panel 18. Although the embodiment of FIGS. 1-6B shows two trolley assemblies 30 forming part of the sliding door assembly 10, a sliding door assembly 10 with one or three or more trolley assemblies 30 on a door panel 18 is contemplated. One consideration for the number of trolley assemblies 30 may be the width of the door panel 18.

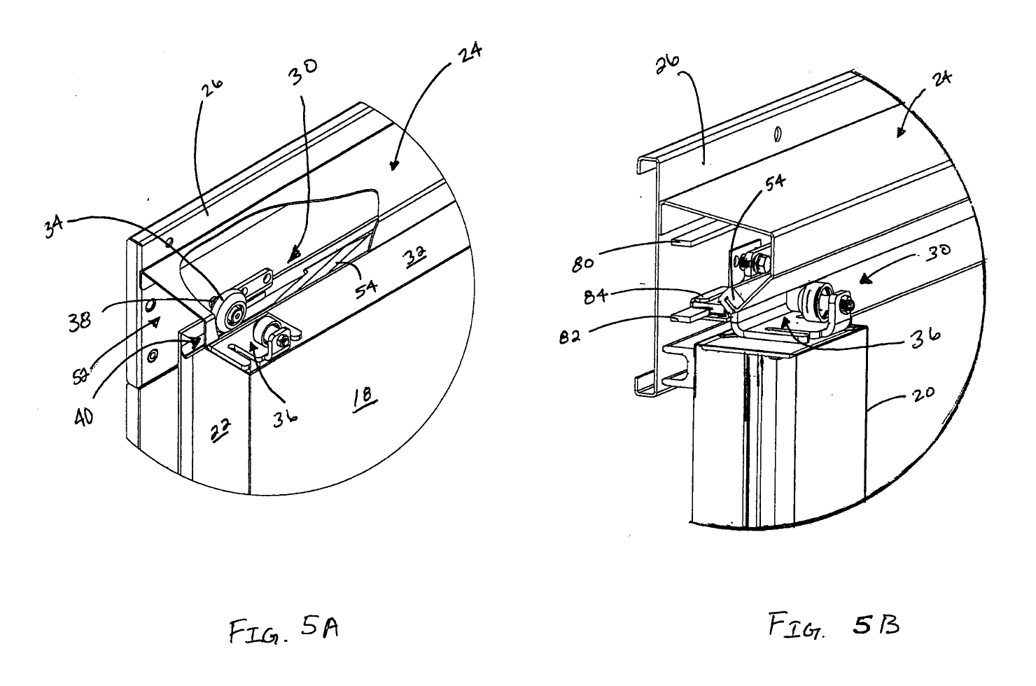

As best illustrated in FIGS. 4 and 5A, each trolley assembly 30 includes a track component 34. The track component 34 in the embodiment shown in FIGS. 1-6A is a roller, however, other forms of track components 34 are contemplated. The track component 34 is connected to a bracket 36 with a fastener 38. The bracket 36 is coupled to the top side 32 of the door panel 18. The track component 34 interacts with a rail 40 that is formed by the shroud 24.

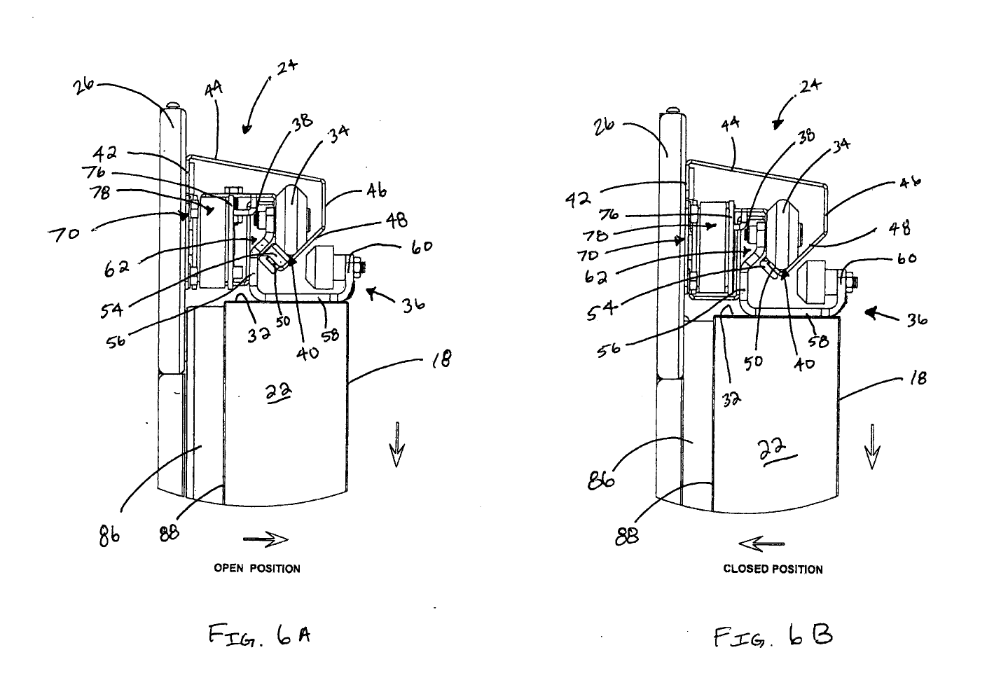

The shroud 24 has a cross-section that is generally C-shaped. As best shown in FIGS. 6A and 6B, one embodiment of the shroud 24 has a base panel 42, a top panel 44, a front panel 46, and an open mouth 52 that faces down. The front panel 46 forms the rail 40 at the connection of a front track panel 48 and a rear track panel 50. The open mouth 52 is formed between the rear track panel 50 and the base panel 42. The base panel 42 is secured to wall 14 and is coupled to the header 26. The door panel 18 is suspended by the trolley assemblies 30 that pass through the open mouth section 52 of the shroud 24. The shroud 24 can also include an insert 54, the purpose of which will be discussed in further detail below. Of course, other shapes and orientations of the shroud 24 are contemplated.

The bracket 36 of each trolley assembly 30 also has a generally C-shaped cross-section. The bracket 36 can include a rear flange 56, a base panel 58, and a front flange 60. The rear flange 64 can include an angled section 62 to facilitate mounting the track component 34 near the rail 40. The bracket 36 extends through the open mouth 52 of the shroud 24 such that the base panel 58 is coupled to the top side 32 of the door panel 18.

The sliding door assembly 10 also includes a drive assembly 70, as best illustrated in FIG. 4. The drive assembly 70 includes an electric motor 72, a drive gear 74, a pulley 76, and an endless drive member 78. In the embodiment shown, the endless drive member 78 is a belt, however, other types of endless drive members 78 can be used, including, but not limited to, a chain. The endless drive member 78 has an upper run 80 and a lower run 82. As best shown in FIG. 5B, a drive attachment 84 grips the lower run 82 of the endless drive member 78 to couple the trolley assembly 30 that is nearest the inward edge 20 of the door panel 18 to the endless drive member 78. As illustrated in FIGS. 6A and 6B, the drive assembly 70 is positioned below the top panel 44 of the shroud 24 and behind a front panel 46 of the shroud 24 such that the shroud 24 encloses and protects the pulley 76 and endless drive member 78. In fact, the shroud 24 encloses and protects substantially the entire length of the endless drive member 78 by extending almost to the motor 72 of the drive system 70.

When the drive assembly 70 is activated to close the door panel 18, the endless drive member 78 moves in a clock-wise direction as viewed from the exterior of the structure 16. The drive attachment 84 grips the lower run 80 of the endless drive member 78, and therefore, the trolley assembly 30 near the inward edge 20 of the door panel 18 slides the door panel 18 to close the door opening 12. As the door panel 18 slides to close the door opening 12, the track components 34 of the trolley assemblies 30 slide along the rail 40 formed by the shroud 24. The drive assembly 70 can also be activated to open the door panel 18 to increase the size of the door opening 12 by operating in a reverse fashion.

As shown in FIGS. 5A-6B, the shroud 24 includes an insert 54 that is placed over the rear track panel 50. The insert 54 is tapered near one end of the shroud 24 to allow the track components 34 on the trolley assemblies 30 to adjust positions in the rail 40 of the shroud 24. For example, as the door panel 18 slides to close the door opening 12 as illustrated in FIG. 6B, the track component 34 moves in a downward direction and closer to the header 26 (to the left in FIG. 6B). This helps to seal the door opening 12 in the structure 16 by compressing the seal 86 that is located on the back side 88 of the door panel 18 against the header 26 and/or a wall 14 of the structure 16, as well as compressing a seal 92 on a bottom side 90 of the door panel 18 against the ground and/or a wall 14 of the structure 16 (see FIG. 2). Likewise, when the door panel 18 slides to open the door opening 12 as illustrated in FIG. 6A, the track component 34 moves in an upward direction and away from the header 26 (to the right in FIG. 6A) to reduce the friction on the seals 86, 92. By reducing the friction on the seals 86, 92 when the door panel 18 is moved to open the door opening 12, the usable life of the seals 86, 92 is increased and the door panel 18 may be opened in a more efficient manner due to less resistance against the drive system 70.

One advantage of the sliding door assembly 10 is that a substantial portion of the drive assembly 70 is covered and protected by the shroud 24. The components of the drive assembly that are covered by the shroud 24 are thus kept free from liquid and debris in the environment in which the sliding door assembly 70 is installed.

The compact nature of the sliding door assembly 10 provides additional advantages for the sliding door assembly 10. As shown in the side elevational views of FIGS. 6A and 6B, the pulley 76 is mounted to the header 26 and the shroud 24 extends over the drive assembly 70 and the track component 34 of the trolley assembly 30 such that the drive assembly 70 is between wall 14 and the trolley assembly 30. The drive assembly 70 is closer to the wall 14 of the structure 16 and/or the header 26 than the rail 40 is to the wall 14 of the structure 16 and/or the header 26. Likewise, the drive assembly 70 is closer to the wall 14 of the structure 16 and/or the header 26 than the track component 34 is to the wall 14 of the structure 16 and/or the header 26. Because the shroud 24 forms the rail 40 for the track component 34, the compact design of the shroud 24 covering the drive system 70 and trolley assembly 30 is beneficial in reducing the torque placed on the shroud 24 because the force placed on the shroud 24 due to the weight of the door panel 18 is kept closer to the wall 14 of the structure 16. By mounting the drive assembly 70 to the header 26, the sliding door assembly 10 does not need additional components to cantilever the drive assembly 70 away from the wall 14 of the structure 18 as in the prior art.

Another advantage to providing a rail 40 that is formed as an integral part of the shroud 24 is a reduction in components. This reduces the cost of the overall sliding door assembly 10 and also provides for a more efficient installation of the sliding door assembly 10.

Many modifications and variations to the preferred embodiment described will be apparent to those skilled in the art. For example, the sliding door assembly 10 can be modified to have two door panels 18 that can be driven by a drive assembly 70 such that the two door panels 18 move in opposite directions to open and close the door opening 12. To do so, one or more trolley assemblies 30 can be coupled to the second door panel 18 and have a drive attachment 84 that grips an upper run 80 of the endless drive member 78 so that the second door panel 18 moves in an opposite direction of the first door panel 18 when the drive assembly 70 is activated.

Another exemplary modification to the sliding door assembly 10 that is contemplated is to recess the drive assembly 70 into the header 26 or the wall 14 of the structure 16. The drive assembly 70 is positioned below the top panel 44 of the shroud 24 and behind the front panel 46 of the shroud 24 as well as between the trolley assembly 30 and the wall 14 of the structure 16. This arrangement provides the additional benefit of further reducing the distance that the shroud 24 would be cantilevered from the header 26 or the wall 14 of the structure 16 to form the rail 40 for the track component 34 of the trolley assembly 30 as compared to prior art systems, which further reduces the torque on the shroud 24.

Therefore, the invention should not be limited to the embodiment described, but should be defined by the claims which follow.

What is claimed is:

1. A laterally sliding door for closing off a door opening in a wall of a structure, the laterally sliding door comprising:
a door panel that extends vertically for substantially the height of the door opening and horizontally between an inward edge of the door panel and an outward edge of the door panel so as to cover at least a portion of the door opening when the door is closed;
a trolley assembly coupled to the door panel, the trolley assembly including a track component;
a shroud for covering the trolley assembly, the shroud forming a rail for the track component; and
a drive assembly for driving the trolley assembly to open and close the door opening, the drive assembly positioned below a top panel of the shroud and behind a front panel of the shroud and between the trolley assembly and the wall.

2. The laterally sliding door of claim 1, wherein at least a portion of the drive assembly is enclosed by the shroud.

3. The laterally sliding door of claim 1, wherein the drive assembly includes a motor, a drive gear, a pulley, and an endless drive member.

4. The laterally sliding door of claim 3, wherein the pulley and a substantial portion of the endless drive member is enclosed by the shroud.

5. The laterally sliding door of claim 1, wherein the shroud has a C-shaped cross-section.

6. The laterally sliding door of claim 5, wherein the C-shaped cross-section includes a base panel, the top panel, the front panel, and an open mouth.

7. The laterally sliding door of claim 6, wherein the front panel forms the rail.

8. The laterally sliding door of claim 7, wherein the front panel includes a front track panel and a rear track panel.

9. The laterally sliding door of claim 6, wherein the open mouth of the C-shaped cross-section is facing down.

10. The laterally sliding door of claim 9, wherein the trolley assembly extends through the open mouth.

11. The laterally sliding door of claim 9, wherein the base panel is secured to the wall.

12. The laterally sliding door of claim 6, wherein the door panel is suspended by the trolley assembly through the open mouth.

13. The laterally sliding door of claim 1, wherein the track component is a roller.

14. The laterally sliding door of claim 1, further comprising a header, wherein the header is coupled to the structure and the shroud is coupled to the header.

15. The laterally sliding door of claim 14, wherein the drive assembly is recessed into the header.

16. The laterally sliding door of claim 1, further comprising:
a second door panel that extends vertically for substantially the height of the door opening and horizontally between an inward edge of the second door panel and an outward edge of the second door panel so as to cover a portion of the door opening when the door is closed;
a second trolley assembly coupled to the second door panel, the second door panel and the door panel meeting near a center of the door opening and opening by moving along the door opening in opposite directions.

17. A sliding door for closing off a door opening in a wall of a structure, the sliding door comprising:
a door panel that extends substantially the height of the door opening and between an inward edge of the door panel and an outward edge of the door panel so as to cover at least a portion of the door opening when the door is closed;
a trolley assembly coupled to the door panel, the trolley assembly including a track component;
a shroud for covering the trolley assembly, the shroud forming a rail for the track component; and
a drive assembly for driving the trolley assembly to open and close the door opening, the drive assembly being closer to the wall of the structure than the rail is to the wall of the structure.

18. The sliding door of claim 17, wherein the shroud has a C-shaped cross-section.

19. The laterally sliding door of claim 17, wherein the front panel forms the rail.

20. A sliding door for closing off a door opening in a wall of a structure, the sliding door comprising:
a header coupled to the wall of the structure;
a door panel that extends substantially the height of the door opening and between an inward edge of the door panel and an outward edge of the door panel so as to cover at least a portion of the door opening when the door is closed;
a trolley assembly coupled to the door panel, the trolley assembly including a track component;
a shroud coupled to the header, the shroud covering the trolley assembly and forming a rail for the track component; and
a drive assembly for driving the trolley assembly to open and close the door opening, the drive assembly being closer to the header than the track component is to the header.
